(19) United States
(12) Patent Application Publication
(10) Pub. No.: US 2026/0052475 A1
(43) Pub. Date: Feb. 19, 2026

(54) RADIO LINK MONITORING USING A LOW-POWER WAKE-UP RADIO IN A WIRELESS DEVICE

(71) Applicant: Apple Inc., Cupertino, CA (US)

(72) Inventors: Jie CUI, San Jose, CA (US); Dawei ZHANG, Saratoga, CA (US); Hong HE, San Jose, CA (US); Manasa RAGHAVAN, Sunnyvale, CA (US); Qiming LI, Beijing (CN); Rolando E. BETTANCOURT ORTEGA, Munich, Bavaria-Bayern (DE); Xiang CHEN, Campbell, CA (US); Yang TANG, San Jose, CA (US); Yuqin CHEN, Shenzhen (CN)

(21) Appl. No.: 19/101,874

(22) PCT Filed: Aug. 8, 2022
(86) PCT No.: PCT/CN2022/110801

§ 371 Date: Feb. 6, 2025

(51) Int. Cl. H04W 52/02; H04L 1/20

(52) U.S. Cl. CPC H04W 52/0235; H04L 1/203

(57) ABSTRACT

This application relates to wireless communications, including methods and apparatus to monitor radio link conditions of a cellular wireless network adaptively using a low-power wake-up signal (LP-WUS) burst received by a low-power wake-up radio (LP-WUR) of a wireless device when possible and switching to using legacy reference signals received by a main radio only when required. The LP-WUS burst is processed by the LP-WUR to determine a block error rate (BLER) value and/or a signal-to-noise-plus-interference ratio (SINR) value to determine whether the wireless device is in an out-of-sync (OOS) condition. The main radio can be awakened, including when directed to sleep by the cellular wireless network, to perform radio link monitoring when the OOS condition is determined.

### FIELD

The described embodiments relate to wireless communications, including methods and apparatus to monitor radio link conditions using a low-power wake-up signal (LP-WUS) received by a low-power wake-up radio (LP-WUR) of a wireless device.

### BACKGROUND

Newer generation, e.g., fifth generation (5G) new radio (NR), cellular wireless networks that implement one or more 3rd Generation Partnership Project (3GPP) 5G standards are rapidly being developed and deployed by network operators worldwide. The newer cellular wireless networks provide a range of packet-based services, with 5G technology providing increased data throughput and lower latency connections that promise enhanced mobile broadband services for wireless devices. The higher data throughput and lower latency of 5G is expected to usher in a range of new applications and services as well as improve existing ones. The 5G technology is being installed in a broad array of wireless devices with different power requirements, and low-power sleep modes are desired to increase the battery life of wireless devices. Release 15 of the 3GPP 5G wireless communication standard introduced a low-power wake-up signal (LP-WUS) to allow a main radio of a wireless device to sleep until awakened based on the LP-WUS. A wireless device is also required to monitor radio link conditions of a cellular wireless network and report measurements at regular intervals. Using the main radio of the wireless device requires higher power consumption than using a separate low-power wake-up radio (LP-WUR) that can be included in the wireless device. There exists a need for mechanisms for wireless devices to monitor radio link conditions adaptively using the LP-WUS received by the LP-WUR when possible, to conserve power, and switch to monitor radio link conditions using legacy reference signals received via the main radio only when necessary.

### SUMMARY

This application relates to wireless communications, including methods and apparatus to monitor radio link conditions of a cellular wireless network adaptively using a low-power wake-up signal (LP-WUS) burst received by a low-power wake-up radio (LP-WUR) of a wireless device, when possible, to conserve power, and switching to monitoring radio link conditions using legacy reference signals received by a main radio of the wireless device only when necessary. The main radio can be placed into a sleep state and wakened to an awake state based on information included in one or more received LP-WUS bursts. The wireless device can perform radio link monitoring (RLM), while in a radio resource control (RRC) connected state, with the main radio in a sleep state, by processing a synchronization portion of the LP-WUS burst to determine evaluation results, e.g., a LP-WUS block error rate (BLER) value and/or a LP-WUS signal-to-noise-plus-interference ratio (SINR) value. The evaluation results calculated from the LP-WUS can be compared to corresponding thresholds to determine whether to wake the main radio of the wireless device to perform RLM using additional signals, e.g., legacy reference signals, received via the main radio. The LP-WUS burst includes N repetitions of a LP-WUS, and the wireless device can determine the evaluation results by processing MEN repetitions of the LP-WUS over an evaluation window and repeating the LP-WUS processing by progressively sliding the evaluation window across the LP-WUS burst. The wireless device performs RLM using received signals of a single LP-WUS burst without combining received signals of separate LP-WUS bursts. Thresholds for the LP-WUS BLER and LP-WUS SINR can differ from respective BLER and SINR thresholds used for RLM based on legacy signals received via the main radio. In some embodiments, a LP-WUS BLER threshold for determining an out-of-sync (OOS) condition is lower than a legacy signal based BLER threshold, while a LP-WUS SINR threshold for determining the OOS condition is higher than a legacy signal based SINR threshold. A lower LP-WUS BLER threshold, at or above which the OOS condition can be determined, and a higher LP-WUS SINR threshold, at or below which the OOS condition can be determined, provide a more rapid OOS determination using the LP-WUS burst than when using the legacy reference signals. When the wireless device determines an OOS condition based on the LP-WUS BLER or LP-WUS SINR value satisfying a corresponding threshold, the wireless device wakes the main radio, including when the LP-WUS burst indicates that the main radio should remain in a sleep state. The wireless device sends a notification to the cellular wireless network to indicate the status change of the main radio of the wireless device from the sleep state to the awake state. The wireless device can subsequently perform RLM, while the main radio is in the awake state, using legacy reference signals received via the main radio. The wireless device performs RLM using the LP-WUS bursts, while the main radio is in the sleep state, and performs RLM, while the main radio is in the awake state, using the legacy reference signals, e.g., a synchronization symbol block (SSB) and/or a channel state information reference signal (CSI-RS). In some embodiments, the wireless device performs RLM monitoring after waking the main radio to the awake state using a relaxed RLM schedule that extends evaluation periods and/or measurement reporting intervals by a positive factor K>1 compared to a normal, non-relaxed RLM schedule. In some embodiments, the wireless device switches from using the relaxed RLM schedule to the normal, non-relaxed RLM schedule when an RLM measurement using the legacy reference signals indicates an OOS condition. In some embodiments, a BLER threshold for switching from the relaxed RLM schedule to the normal, non-relaxed RLM schedule requires a BLER measurement that exceeds a BLER threshold used for determining the OOS condition adjusted lower by a negative BLER offset threshold value (or equivalently adding a positive BLER offset threshold value to the BLER measurement and comparing the adjusted BLER measurement to the normal OOS BLER threshold).

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to perform radio link monitoring (RLM) by a wireless device, according to some embodiments.

FIG. 2A illustrates diagrams of exemplary power reduction mechanisms for a wireless device, according to some embodiments.

FIG. 2B illustrates additional diagrams of exemplary power reduction mechanisms for a wireless device, according to some embodiments.

FIG. 3 illustrates a diagram of an example of RLM using a low-power wake-up signal (LP-WUS) by a wireless device, according to some embodiments.

FIG. 4 illustrates diagrams of exemplary configurations of a LP-WUS, according to some embodiments.

FIG. 5 illustrates diagrams of an example of adapting synchronization conditions based on signals used for RLM by a wireless device, according to some embodiments.

FIG. 6A illustrates a diagram of an example of adaptive RLM by a wireless device, according to some embodiments.

FIG. 6B illustrates a diagram of an exemplary mapping of evaluation results using different radios of a wireless device, according to some embodiments.

FIG. 7 illustrates a flowchart of an exemplary method for RLM by a wireless device, according to some embodiments.

FIG. 8 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus to monitor radio link conditions of a cellular wireless network adaptively using a low-power wake-up signal (LP-WUS) burst received by a low-power wake-up radio (LP-WUR) of a wireless device, when possible, to conserve power, and switching to using legacy reference signals received by a main radio of the wireless device only when required. The main radio includes wireless circuitry for performing data transmission and reception, control signaling, and radio link monitoring (RLM) using legacy reference signals. The LP-WUR includes additional wireless circuitry to support limited functionality for the wireless device while the main radio is in a power-reduced, sleep state. The main radio can be placed into the sleep state and wakened to an awake state based on information included in one or more LP-WUS bursts received and processed by the LP-WUR. The main radio can transition from the sleep state to the awake state or from the awake state to the sleep state based on indications included in an information portion of a LP-WUS burst received via the LP-WUR. As discussed further herein, the main radio can also transition from the sleep state to the awake state, including when the information part of the LP-WUS indicates the main radio should be in the sleep state, based on a determination of radio link conditions from an evaluation of a synchronization portion of a LP-WUS repetitions of a LP-WUS burst.

The wireless device can perform radio link monitoring (RLM), while in a radio resource control (RRC) connected state with the main radio in a sleep state, by processing a synchronization portion of LP-WUS repetitions of the LP-WUS burst to determine evaluation results, e.g., a LP-WUS block error rate (BLER) value and/or a LP-WUS signal-to-noise-plus-interference ratio (SINR) value. The evaluation results calculated from the LP-WUS can be compared to corresponding thresholds to determine whether to wake the main radio of the wireless device to perform RLM using additional legacy reference signals received via the main radio. The LP-WUS burst includes N repetitions of a LP-WUS, and the wireless device can determine the evaluation results by processing MEN repetitions of the LP-WUS over an evaluation window and repeating the LP-WUS processing by progressively sliding the evaluation window across the LP-WUS burst. The wireless device can use a sliding step value corresponding to a spacing of individual LP-WUS repetitions included in the LP-WUS burst. The wireless device performs RLM using received signals of a single LP-WUS burst without combining received signals of separate LP-WUS bursts.

Thresholds for the LP-WUS BLER and LP-WUS SINR can differ from BLER and SINR thresholds configured by the cellular wireless network and used for RLM based on legacy signals received via the main radio. In some embodiments, a LP-WUS BLER threshold for determining an out-of-sync (OOS) condition, using the LP-WUS while the main radio is in a sleep state, is lower than a legacy signal based BLER threshold for determining the OOS condition using legacy reference signals while the main radio is in an awake state. In some embodiments, a LP-WUS SINR threshold for determining the OOS condition, using the LP-WUS while the main radio is in the sleep state, is higher than a legacy signal based SINR threshold for determining the OOS condition using legacy reference signals while the main radio is in an awake state. The LP-WUS BLER threshold can equal a main radio BLER threshold plus a negative BLER offset value. Similarly, the LP-WUS SINR threshold can equal a main radio SINR threshold plus a positive SINR offset value. A lower LP-WUS BLER threshold, above which the OOS condition can be determined, and a higher LP-WUS SINR threshold, below which the OOS condition can be determined, provide a more rapid OOS determination using the LP-WUS burst than when using the legacy reference signals.

When the wireless device determines an OOS condition, based on the LP-WUS BLER value or LP-WUS SINR value satisfying a corresponding threshold, the wireless device wakes the main radio, including when the information part of the LP-WUS burst indicates the main radio is to remain in a sleep state. The LP-WUS OOS condition overrides the network sleep indication for the main radio. After waking the main radio, the wireless device sends a notification to the cellular wireless network, via the main radio, to indicate the status change of the main radio of the wireless device from the sleep state to the awake state. The wireless device can subsequently perform RLM, while the main radio is in the awake state, using legacy reference signals received an processed via the main radio, e.g., to confirm the OOS condition.

The wireless device performs RLM, while the main radio is in the sleep state, using the LP-WUS bursts and performs RLM, while the main radio is in the awake state, using the legacy reference signals, e.g., a synchronization symbol block (SSB) and/or a channel state information reference signal (CSI-RS). The wireless device restarts RLM anew after transitioning the main radio between a sleep state and an awake state and discards partial RLM results accumulated before the state transition. The wireless device can use a different evaluation time period while the main radio is in the sleep state from when the main radio is in the awake state. In some embodiments, the wireless device performs RLM monitoring after waking the main radio to the awake state using a relaxed RLM schedule that extends evaluation periods and/or measurement reporting intervals by a positive factor K>1 compared to a normal, non-relaxed RLM schedule. In some embodiments, the wireless device switches from using the relaxed (less frequent) RLM schedule to the normal, non-relaxed (more frequent) RLM schedule when an RLM measurement, obtained from legacy reference signals received via the main radio while in the awake state, indicates an OOS condition. In some embodiments, the wireless device switches from using the relaxed RLM schedule to the normal, non-relaxed RLM schedule when a BLER measurement obtained using the legacy reference signals plus a positive BLER offset threshold value exceeds a main radio OOS BLER threshold.

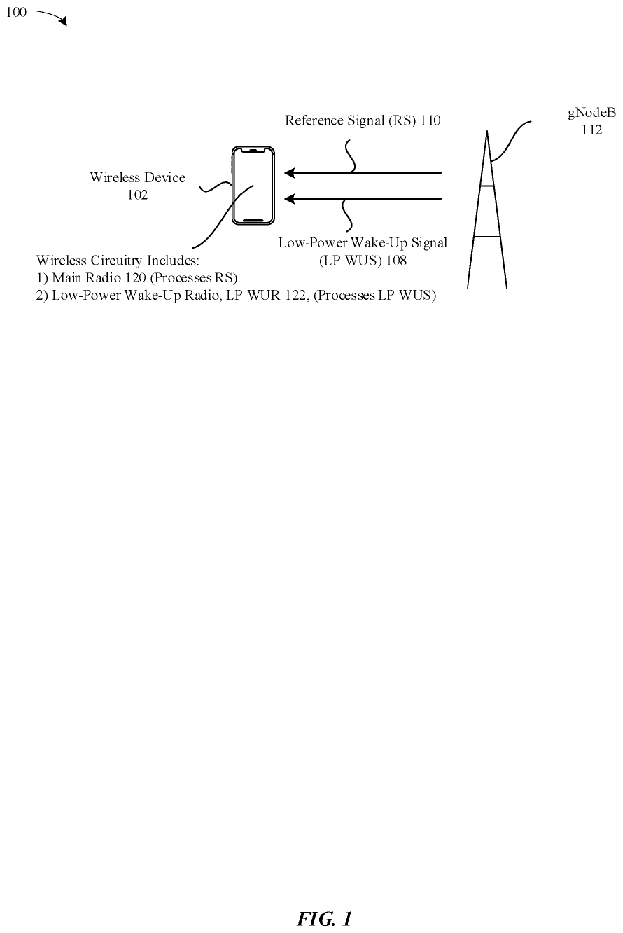

These and other embodiments are discussed below with reference to FIGS. 1 through 8; however, those skilled in the art will readily appreciate that the detailed description given herein with respect to these figures is for explanatory purposes only and should not be construed as limiting.

FIG. 1 illustrates a block diagram 100 of different components of an exemplary system configured to perform radio link monitoring (RLM). A wireless device 102 contains wireless circuitry that includes a main radio 120 and a low-power wake-up radio (LP-WUR) 122 and receives downlink signals from a gNodeB 112 of a cellular wireless network. The main radio 120 is used for data and control signal transmission and reception and for radio link monitoring (RLM) using legacy reference signals 110 received in the downlink direction from the cellular wireless network. The LP-WUR 122 is a low-power component used to support limited functions including reception of a low-power wake-up signal (LP-WUS) 108 that provides an indication from the gNodeB 112 of the cellular wireless network whether to wake the main radio 120 from a power-reduced sleep state. The gNodeB 112 of the cellular wireless network can transmit both the LP-WUS 108 and the legacy reference signals 110 to allow the wireless device 102 to receive and use each type of signal accordingly. Legacy reference signals 110 can include a synchronization symbol block (SSB), which includes i) a primary synchronization signal (PSS) and a secondary synchronization signal (SSS) used by the wireless device 102 to locate, identify, and synchronize to cellular wireless networks, and ii) a physical broadcast channel (PBCH) system information. Additional legacy reference signals 110 can include a demodulation reference signal (DM-RS) used for channel estimation, system information (SI) signals, such as channel state information reference signals (CSI-RS) used for channel estimation, time tracking, and frequency tracking. When the main radio 120 of the wireless device 102 is in a power-reduced sleep state, the LP-WUR 122 is not configurable to process the legacy reference signals. As radio link monitoring of the communication channel and wireless environment of the wireless device 102 at regular intervals is required for proper functioning, the wireless device 102 can wake the main radio 120 to monitor the legacy reference signals; however, using the main radio 120 for RLM can consume additional power, negating in part the benefits of the power-reduced sleep mode. As described herein, the wireless device 102 can instead perform RLM using the LP-WUS 108 using the LP-WUR 122 to save power and enable the main radio 120 to perform RLM only under certain observed conditions.

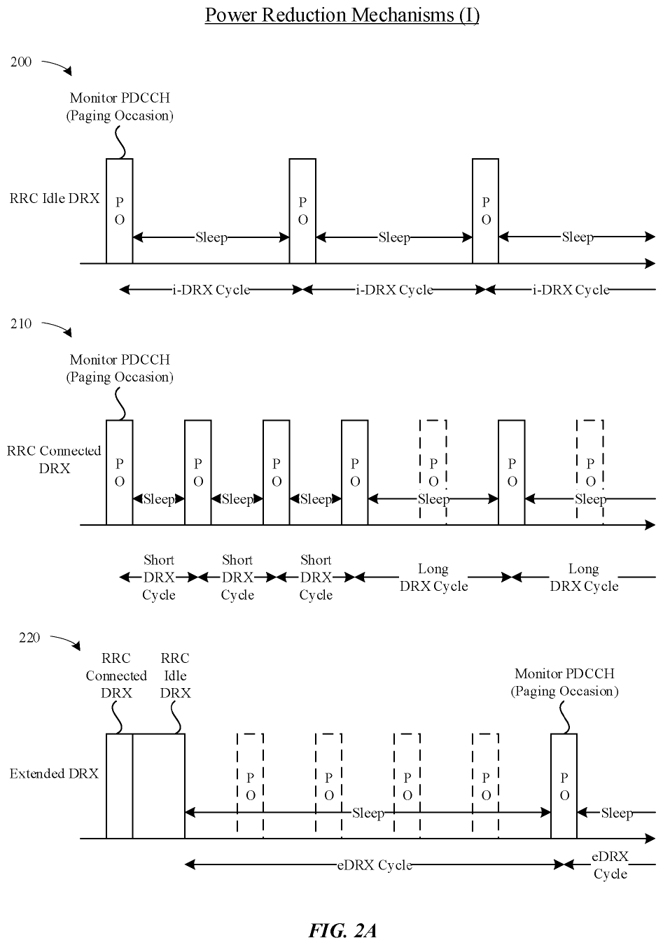

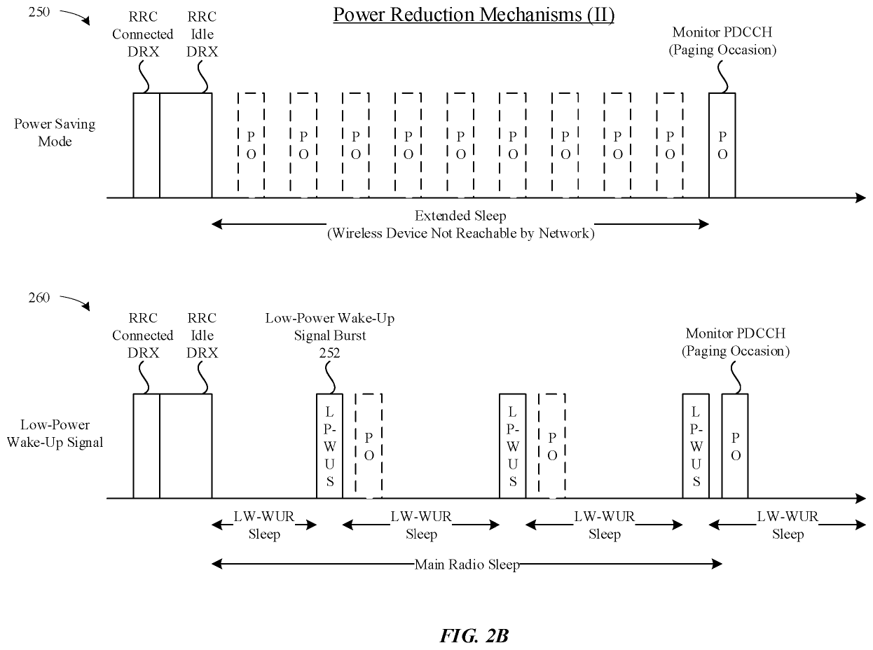

FIGS. 2A and 2B illustrates diagrams 200, 210, 220, 250, and 260 of various power reduction mechanisms for a wireless device 102. The wireless device 102 can be in one of several defined states including a radio resource control (RRC) idle state and a RRC connected state. In the RRC idled state, data transmission and reception are disallowed, there is no established RRC context with the cellular wireless network, and there is no established connection to the core network portion of the cellular wireless network; however, the wireless device 102 can receive paging messages. In the RRC connected state, data transmission and reception is allowed, there are an established RRC context with the cellular wireless network, there is an established connection to the core network portion of the cellular wireless network. Power consumption while in the RRC connected state is higher than in the RRC idle state. The wireless device 102 can be configured for discontinuous reception (DRX) to reduce power consumption while in the RRC idle state and while in the RRC connected state.

As shown in diagram 200, a wireless device 102, while in an RRC idle DRX (i-DRX) mode, can maintain a main radio 120 of the wireless device 102 in a sleep state and wake the main radio 120, at regular intervals of i-DRX cycles, to monitor a physical downlink control channel (PDCCH) during a paging occasion (PO) to determine whether downlink data is scheduled for transmission to the wireless device 102. When there is downlink data available, the main radio 120 of the wireless device 102 can remain awake (or waken at a specific designated time) to receive the downlink data. When there is no downlink data available, the main radio 120 of the wireless device 102 can return to the sleep state.

As shown in diagram 210, a wireless device 102, while in an RRC connected DRX (c-DRX) mode, can wake the main radio 120 from a sleep state at regular intervals of a short DRX cycle to monitor the PDCCH of a paging occasion, and maintain the main radio 120 in the sleep state in between when no downlink data is available. After a period of time using the short DRX cycle with no data available, the wireless device 102 transitions to using a long DRX cycle, monitoring the PDCCH of paging occasions spaced further apart in time.

As shown in diagram 220, a wireless device 102 can use an extended DRX cycle (eDRX) after a period of time using the c-DRX mode followed by the i-DRX mode. With increasing lengths of sleep periods, responsiveness of the wireless device 102 decreases, because the wireless device 102 can be unable to monitor a paging occasion until scheduled according to the DRX cycle in use. As shown in diagram 250, a wireless device 102 can use an extended sleep period while in a power saving mode and be unreachable by the cellular wireless network while in the extended sleep state. To overcome this deficiency, the cellular wireless network can use a low-power wake-up signal (LP-WUS) 108 in advance of a paging occasion.

As shown in diagram 260, a wireless device 102 can be configured to allow a main radio 120 to enter a sleep state after completion of data reception, and in some cases, after using a c-DRX state followed by an i-DRX state. While the main radio 120 is in the sleep state, the wireless device 102 can use a low-power wake-up radio (LP-WUR) 122 to monitor for the LP-WUS 108. When the LP-WUS 108 indicates the main radio 120 should be wakened from the sleep state, the wireless device 102 can transition the main radio 120 to an awake state and monitor the PDCCH during a subsequent paging occasion. When the LP-WUS 108 indicates the main radio 120 should remain in the sleep state, the wireless device 102 can return the LP-WUR to a sleep state and await the next LP-WUS 108.

While in an RRC connected state, a wireless device 102 can be required to monitor radio link channel conditions at a physical layer (layer 1, or L1) and report information, such as in-sync and out-of-sync indications, to higher layer functions. Successive reports from the physical layer to the higher layers can occur regularly based on a configured reporting interval. The wireless device 102 can use the main radio 120 for monitoring legacy reference signals from the cellular wireless network, such as a SSB including PSS/SSS and PBCH, and DM-RS and CSI-RS signals. The main radio 120 of the wireless device 102 can monitor the legacy reference signals received at multiple instances over an evaluation window (time period) and subsequently report information obtained from processing the legacy reference signals at a reporting (layer 1 indication) interval, which can be based on a power-saving mode in which the wireless device 102 is configured, e.g., shorter reporting while in an active mode and longer reporting while in a DRX mode. To conserve power, the wireless device 102 can monitor the LP-WUS 108 using the LP-WUR 122 instead of using the main radio 120 to monitor the legacy reference signals 110, leaving the main radio 120 in a sleep state, until certain criteria are satisfied.

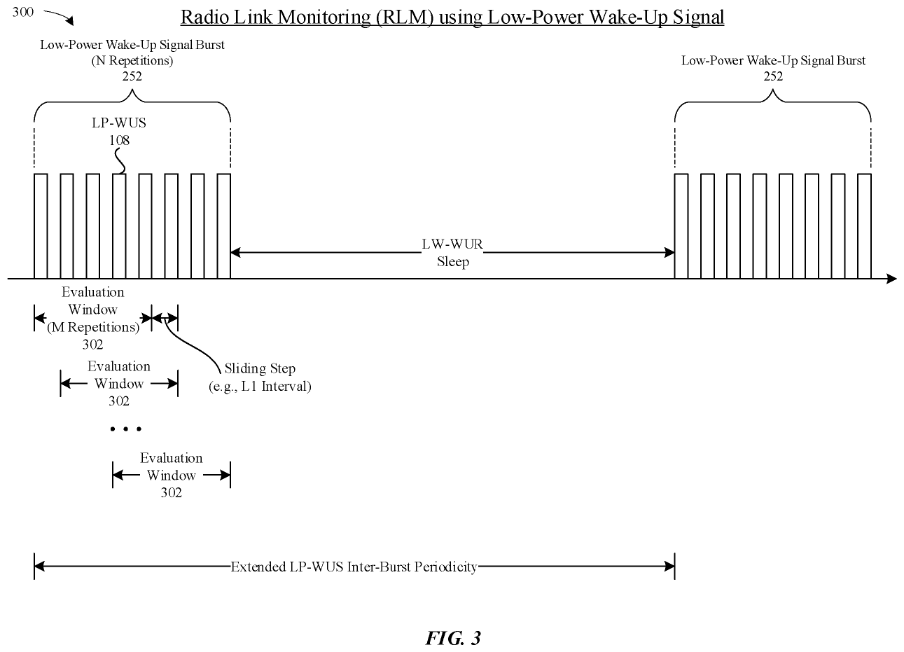

FIG. 3 illustrates a diagram 300 of an exemplary mechanism for a wireless device 102 to perform RLM using the LP-WUS 108. A cellular wireless network can send a LP-WUS burst 252 that includes N repetitions of the LP-WUS 108. A LP-WUR 122 of the wireless device 102 can monitor the LP-WUS 108 for indications of whether a main radio 120 should remain in a sleep state or enter an awake state. The LP-WUR 122 of the wireless device 102 can process M repetitions of the LP-WUS 108 over an evaluation window 302 and determine one or more channel metrics by processing the LP-WUS 108 repetitions. In some embodiments, the LP-WUS 108 includes a synchronization portion that can be used for channel measurements based on processing the synchronization portion of the LP-WUS 108 to determine a LP-WUS block error rate (BLER) and/or a LP-WUS signal-to-interference-plus-noise ratio (SINR). In some embodiments, the LP-WUR 122 of the wireless device 102 determines whether the wireless device 102 is in an in-sync condition or an out-of-sync condition based on channel metrics obtained by monitoring the LP-WUS 108 repetitions. In some embodiments, the LP-WUR 122 of the wireless device 102 performs repeated evaluations by sliding an evaluation window 302 by a sliding step time interval, which can be associated with a layer 1 (L1) measurement interval and/or reporting interval. The LP-WUR 122 of the wireless device 102 can receive and process LP-WUS bursts 252 individually, with separate LP-WUS bursts 252 spaced apart by an extended LP-WUS inter-burst interval. In some embodiments, channel metrics are obtained by processing only LP-WUS 108 repetitions within a single LP-WUS bursts 252, and LP-WUS 108 repetitions in widely separated LP-WUS bursts 252 are not combined. When the number of LP-WUS 108 repetitions in an LP-WUS burst 252 is equal to or less than a number of samples needed for an RLM evaluation, the wireless device 102 uses all of the samples of the LP-WUS burst 252 (and does not use samples from other or adjacent LP-WUS bursts 252). In some embodiments, the wireless device 102 uses averaging and/or filtering of sample values from LP-WUS 108 repetitions across an evaluation window 302, and confines the averaging and/or filtering to samples values of a single LP-WUS burst 252, i.e., averaging and/or filtering is not performed across LP-WUS bursts 252. When the number of LP-WUS 108 repetitions in an LP-WUS burst 252 exceeds a number of samples needed for an RLM evaluation, the LP-WUR 122 of the wireless device 102 can average/filter across an evaluation window 302 spanning the number of samples needed for the RLM evaluation and subsequently repeat the evaluation by sliding the evaluation window 302 by a step interval, e.g., by one LP-WUS 108 repetition, and repeating the RLM evaluation.

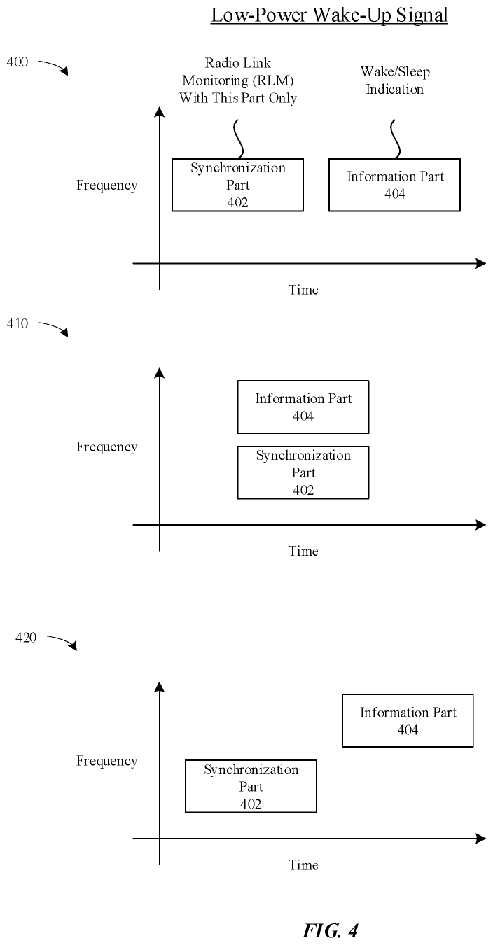

FIG. 4 illustrates diagrams 400, 410, and 420 of exemplary configurations for different portions of the LP-WUS 108. The LP-WUS 108 includes a synchronization part 402, which can be a synchronization sequence and can be used for synchronization, timing, and frequency tracking by the LP-WUR 122 of the wireless device 102. The LP-WUS 108 also includes an information part 404 that can provide a dormancy (sleep/wake state) indication for the main radio 120 of the wireless device 102. When the information part 404 of the LP-WUS 108 indicates that the main radio 120 of the wireless device 102 is to remain (or to enter) a sleep state, the LP-WUR 122 of the wireless device 102 can process the synchronization part of the LP-WUS 108 to determine one or more wireless channel measurements. When the information part 404 of the LP-WUS 108 indicates that the main radio 120 of the wireless device 102 is to enter a wake state, the main radio 120 of the wireless device 102 can be used to determine one or more wireless channel measurements using one or more legacy reference signals 110. In some embodiments, the LP-WUR 122 of the wireless device 102 processes the synchronization part of the LP-WUS 108 to perform synchronization, timing, and frequency tracking functions while the main radio 120 of the wireless device 102 remains in the sleep state. The LP-WUS 108 can use different configurations across time and frequency dimensions, such as using a common set of radio frequencies at different time intervals, as shown in diagram 400, using a common time interval across different radio frequency bands, as shown in diagram 410, or using separate time intervals and different radio frequency bands, as shown in diagram 420.

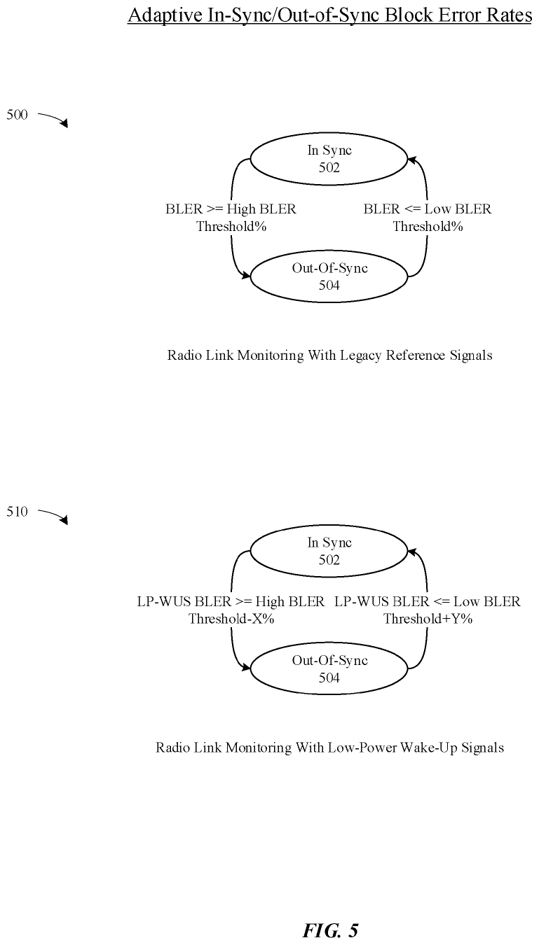

FIG. 5 illustrates diagrams 500, 510 for using select wireless channel measurements to determine an in-sync or out-of-sync (OOS) condition for a wireless device 102. Different thresholds can be used when processing legacy reference signals 110 than when processing LP-WUS 108 repetitions of a LP-WUS burst 252. When the main radio 120 of the wireless device 102 determines a block error rate (BLER) value using the legacy reference signals 110, the main radio 120 can determine an in-sync 502 condition for the wireless device 102 when the BLER satisfies (e.g., equals or falls below) a low BLER threshold percentage value, and the main radio 120 can determine an out-of-sync (OOS) 504 condition for the wireless device 102 when the BLER satisfies (e.g., equals or exceeds) a high BLER threshold percentage value. A representative high BLER threshold percentage value, at or above which an OOS condition can be determined, can be 10%, while a representative low BLER threshold percentage value, at or below which an in-sync condition can be determined, can be 2%. In between the low and high BLER threshold values, the main radio 120 of the wireless device 102 can maintain a previously determined in-sync/OOS condition. The cellular wireless network to which the wireless device 102 is associated can set the low BLER and/or high BLER threshold percentage values, in some embodiments. When the LP-WUR 122 of the wireless device 102 determines a LP-WUS BLER value using the LP-WUS 108 repetitions of a LP-WUS burst 252, the LP-WUR 122 can determine an in-sync 502 condition for the wireless device 102 when the LP-WUS BLER satisfies (e.g., equals or falls below) a low LP-WUS BLER threshold percentage value, which can be higher than the low BLER threshold percentage value used for legacy reference signal radio link monitoring by a positive offset amount, e.g., Y % higher. The offset amount can allow the LP-WUR 122 to transition from an OOS condition to an in-sync condition more quickly. Similarly, when the LP-WUR 122 of the wireless device 102 determines a LP-WUS BLER value using the LP-WUS 108 repetitions of a LP-WUS burst 252, the LP-WUR 122 can determine an out-of-sync (OOS) 504 condition for the wireless device 102 when the LP-WUS BLER satisfies (e.g., equals or exceeds) a high LP-WUS BLER threshold percentage value, which can be lower than the corresponding high BLER threshold percentage value used for legacy reference signal monitoring by a negative offset amount, e.g., X % lower. The offset amount can allow the LP-WUR 122 to transition from an in-sync condition to an OOS condition more quickly. A representative high LP-WUS BLER threshold percentage value, at or above which an OOS condition can be determined, can be 10−X %, while a representative low LP-WUS BLER threshold percentage value, at or below which an in-sync condition can be determined, can be 2+Y %. In between the low and high LP-WUS BLER threshold values, the main radio 120 of the wireless device 102 can maintain a previously determined in-sync/OOS condition.

In some embodiments, the wireless device 102 estimates an SINR value using the LP-WUS 108 repetitions of a LP-WUS burst 252 and uses the estimated SINR value alone or in combination with the LP-WUS BLER to determine whether to declare an in-sync or OOS condition for the wireless device 102. The cellular wireless network to which the wireless device 102 is associated can set low SINR value threshold and/or high SINR threshold values for the wireless device 102 to use when measuring legacy reference signals 110, in some embodiments. The wireless device 102 can determine adjusted low and high LP-WUS SINR threshold values to use based on the network-configured low and high SINR threshold values, e.g., by adding an offset to the low SINR threshold below which an OOS condition can be determined and/or by subtracting an offset from the high SINR threshold above which an in-sync condition can be determined.

The wireless device 102 can use both the main radio 120 and the LP-WUR 122 at different times to monitor radio link conditions and switch between use of the LP-WUR 122 to use of the main radio 120 based on select criteria being met. In some embodiments, the LP-WUR 122 monitors the radio link conditions using the LP-WUS 108 repetitions of a LP-WUS burst 252 when the information part of the LP-WUS 108 indicates the main radio 120 should remain asleep. In some embodiments, the LP-WUR 122 wakes the main radio 120 from a sleep state to an awake state and monitors the radio link conditions using the legacy reference signals 110 when the information part of one or more repetitions of a LP-WUS burst 252 indicate the main radio 120 should awaken from the sleep state and transition to the awake state. In some embodiments, when the LP-WUS BLER satisfies a low LP-WUS BLER threshold, indicating an OOS condition, the wireless device 102 wakes the main radio 120 from a sleep state to an awake state and monitors the radio link conditions using the legacy reference signals 110, independent of whether the information part of the LP-WUS 108 indicates the main radio 120 should remain asleep. The wireless device 102 can similarly use SINR threshold in place of or in addition to the BLER thresholds to determine whether to wake the main radio 120 from a sleep state.

Accuracy for measurements of radio link conditions is expected to be higher using the main radio 120 with legacy reference signals 110 than by using the LP-WUR 122 with the LP-WUS bursts 252. In some embodiments, the LP-WUR 122 wakes the main radio 120 from a sleep state, independent of an indication to remain in a sleep state included in the information part of the LP-WUS 108 repetitions of a LP-WUS burst 252, when an LP-WUS BLER and/or an LP-WUS SINR value satisfies an LP-WUS BLER threshold value or an LP-WUS SINR threshold value for declaring an OOS condition. In some embodiments, the wireless device 102 adds an offset margin, e.g., an additional Z %, to the LP-WUS BLER threshold value to use to determine whether to wake the main radio 120 from the sleep state. In some embodiments, the wireless device 102 requires a lower LP-WUS SINR threshold, e.g., by Z % less than normal, in order to determine to wake the main radio 120 from the sleep state. Under worsening radio link conditions with measured LP-WUS BLER increasing, while the main radio 120 is in a sleep state, the wireless device 102 can first determine an OOS condition, e.g., when the LP-WUS BLER crosses the LP-WUS BLER threshold value, and then can determine to wake the main radio 120 from the sleep state, e.g., when the LP-WUS BLER crosses the higher (by Z %) LP-WUS BLER threshold value. Once the main radio 120 is wakened, the wireless device 102 can determine whether the OOS condition is valid using received legacy reference signals 110. Similarly, the wireless device 102, in some embodiments, can use an adjusted SINR value to determine whether to waken the main radio 120 from a sleep state. In some embodiments, an offset value (e.g., Z %) to use for an adjusted LP-WUS BLER threshold or an adjusted LP-WUS SINR threshold (for waking the main radio 120) can be pre-configured in the wireless device 102 or configured by the cellular wireless network.

In some embodiments, when the wireless device 102 switches between monitoring radio link conditions using legacy reference signals 110 and LP-WUS 108 repetitions of LP-WUS bursts 252, accumulated data, partial measurements, and/or historical measurements can be discarded or ignored. In some embodiments, determinations for in-sync or OOS can be based solely on measurements taken using legacy reference signals 110 or using LP-WUS bursts 252 but will not mix measurements of both. In some embodiments, evaluation time periods, e.g., lengths of evaluation windows over which measurements can be taken, averaged, and/or filtered are based on the signals used for the measurements. Thus, evaluation time periods for legacy reference signals 110 and evaluation periods for LP-WUS bursts 252 can differ. Evaluation samples obtained using one type of signal, e.g., based on legacy reference signals 110, can be discarded when switching to RLM using the LP-WUS bursts 252. Similarly, evaluation samples obtained based on the LP-WUS bursts 252 can be discarded when switching to RLM using the legacy reference signals 110.

The LP-WUS bursts 252 can be communicated with different power levels than legacy reference signals 110, and therefore RLM measurements using the LP-WUS bursts 252 can vary from those based on the legacy reference signals 110. LP-WUS based parameters and threshold values can be scaled according to the power differences between the time/frequency resource elements of the LP-WUS bursts 252 to the corresponding time/frequency resource elements used by the legacy reference signals. In some embodiments, an average LP-WUS resource element (RE) energy level can be 4+K dB lower than a physical downlink control channel (PDCCH) RE. In some embodiments, an average LP-WUS RE energy level can be 4+K dB lower than a PDCCH downlink modulation reference signal (DM-RS) energy level.

In some embodiments, the cellular wireless network configures a number of receive antennas, e.g., one antenna, two antennas, etc., to be used with the LP-WUS bursts 252 for radio link monitoring or other measurements. In some embodiments, the number of receive antennas to be used for RLM with LP-WUS bursts 252 is preconfigured based on a 3GPP wireless communication standard.

A wireless device 102 can perform layer 3 (L3) measurements in addition to layer 1(L1) radio link monitoring. In some cases, L1 RLM and L3 measurements can be scheduled separately with different periodicities. In some cases, a time period for an L1 RLM measurement can overlap (collide) with a time period for an L3 measurement. In some embodiments, L3 measurements based on LP-WUS bursts 252 can be prioritized higher than L1 RLM measurements based on LP-WUS bursts 252. In some embodiments, L1 RLM measurements based on LP-WUS bursts 252 can be prioritized higher than L3 measurements based on legacy reference signals 110.

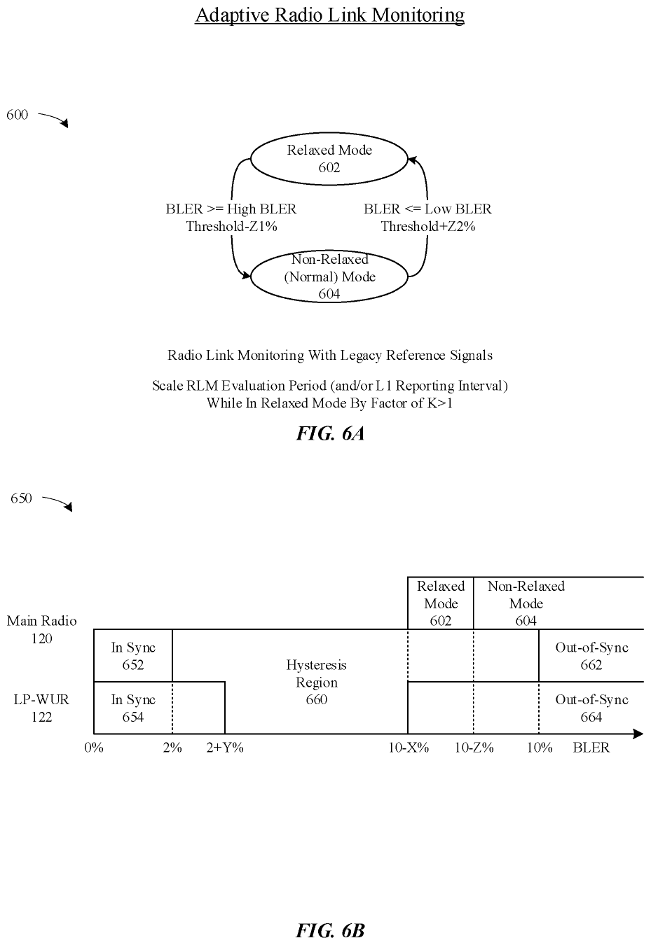

FIG. 6A illustrates a diagram 600 for adaptive RLM when processing legacy reference signals 110 by a main radio 120 of a wireless device 102. As discussed herein, the wireless device 102 can wake a main radio 120 from a sleep state responsive to a determination of a high BLER, a low SINR, or an OOS condition (based on RLM using LP-WUS bursts 252). The cellular wireless network can continue to send LP-WUS bursts 252 that indicate the main radio 120 should be in a sleep state; however, the wireless device 102 can keep the main radio 120 in an awake state to perform RLM using the legacy reference signals 110 (which can be unable to be processed by the LP-WUR 122 of the wireless device 102). The wireless device 102 can use an elongated (relaxed) evaluation time period and/or layer 1 (L1) reporting interval while in a relaxed mode 602, e.g., scale the evaluation time period by a positive factor K>1 and/or scale the L1 interval by a positive factor K>1. The main radio 120 of the wireless device 102 can switch from the relaxed mode 602 to a normal (non-relaxed, non-elongated) mode 604 when a BLER measurement satisfies a BLER threshold for an OOS condition (or exceeds the BLER threshold for an OOS condition by an offset value of Z1%). Alternatively, and/or additionally, the main radio 120 of the wireless device 102 can switch from the relaxed mode 602 to a normal (non-relaxed, non-elongated) mode 604 when an SINR measurement satisfies an SINR threshold for an OOS condition (or falls below the SINR threshold for an OOS condition by an offset value of Y1%). In some embodiments, the main radio 120 of the wireless device 102 can switch from the normal mode 604 to the relaxed mode 602 when a BLER measurement satisfies a BLER threshold for an in-sync condition (or falls below the BLER threshold for an in-sync condition by an offset value of Z2%). Alternatively, and/or additionally, in some embodiments, the main radio 120 of the wireless device 102 can switch from the normal mode 604 to the relaxed mode 602 when an SINR measurement satisfies an SINR threshold for an in-sync condition (or exceeds the SINR threshold for an OOS condition by an offset value of Y2%).

In some embodiments, the wireless device 102 performs radio link monitoring (RLM) using a LP-WUR 122 by processing LP-WUS 108 repetitions of LP-WUS bursts 252 when the main radio 120 of the wireless device 102 is in a sleep state and an OOS condition is not satisfied based on the RLM using the LP-WUS bursts 252. In some embodiments, the wireless device 102 wakes a main radio 120 from the sleep state and performs RLM using legacy reference signals 110 when an OOS condition is satisfied based on the RLM using the LP-WUS bursts 252, including when the LP-WUS bursts indicate that the main radio 120 should be in a sleep state. In some embodiments, RLM using the legacy reference signals 110 can be performed using a relaxed (time-extended) schedule after waking the main radio 120 based on the OOS condition being satisfied based on the LP-WUS RLM measurements. In some embodiments, RLM using the legacy reference signals 110 can be performed using a normal (not time-extended) schedule when an OOS condition is satisfied based on legacy reference RLM measurements and/or when waking the main radio 120 based on a wake indication received in an LP-WUS burst 252.

FIG. 6B illustrates a diagram 650 of an exemplary mapping of an evaluation result, e.g., a BLER value, to different synchronization conditions and modes of operation. The wireless device 102 can perform RLM using the LP-WUR 122 when the main radio 120 is in a sleep state and determine whether the wireless device 102 is in-sync or out-of-sync (OOS) based on measurements taken using LP-WUS 108 repetitions of LP-WUS bursts 252. The LP-WUR in-sync region 654 can be wider (encompass more BLER values) than the corresponding main radio in-sync region 652, e.g., by an additional Y % of BLER values. Similarly, the LP-WUR OOS region 664 can be wider than the corresponding main radio OOS region 662, e.g., by an additional X % of BLER values. Using the LP-WUR 122, the wireless device 102 can more rapidly determine an in-sync condition or an OOS condition as BLER values change. When an OOS condition is determined using the LP-WUR 122, the wireless device 102 can wake the main radio 120 and perform RLM using the main radio 120 based on measurements of legacy reference signals 110. Initially, when crossing into the OOS region 664, the wireless device 102 can configure the main radio 120 to use a relaxed mode 602 schedule for RLM. When a BLER determined using the legacy reference signals processed by the main radio 120 crosses a boundary below the OOS region 662 for the main radio 120, e.g., wider by an additional Z %, the main radio 120 can transition from using the relaxed mode 602 schedule for RLM to using a normal, non-relaxed mode 604 schedule for RLM. In between the in-sync and OOS regions, the wireless device 102 operates in a hysteresis region 660 maintaining a previously determined (and current) in-sync/OOS condition until a BLER threshold is satisfied for changing the determination. FIG. 6B illustrates a BLER example, and similar partitioning based on SINR values can be used in place of or in addition to use of BLER values for an in-sync/OOS determination by the wireless device 102.

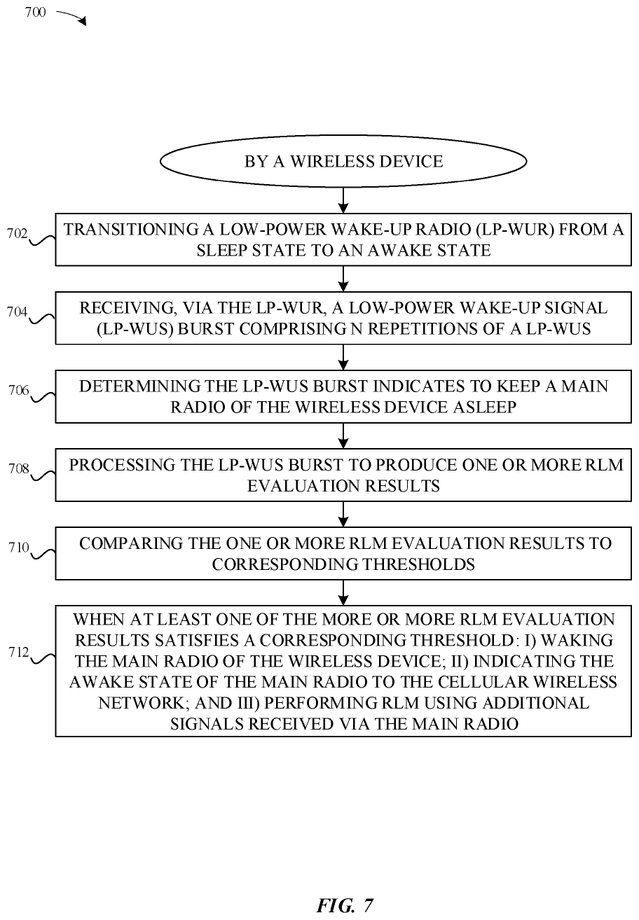

FIG. 7 illustrates a flowchart 700 of an exemplary method for radio link monitoring (RLM) performed by a wireless device 102. At 702, the wireless device 102 transitions a low-power wake-up radio (LP-WUR) 122 from a sleep state to an awake state. At 704, the wireless device 102 receives, via the LP-WUR 122, a low-power wake-up signal (LP-WUS) burst 252 that includes N repetitions of a LP-WUS 108. At 706, the wireless device 102 determines that the LP-WUS burst 252 indicates to keep a main radio 120 of the wireless device 102 asleep. At 708, the wireless device 102 processes the LP-WUS burst 252 to produce one or more RLM evaluation results (measurements for performance evaluation). At 710, the wireless device 102 compares the one or more RLM evaluation results to corresponding thresholds. At 712, when at least one of the one or more RLM evaluation results satisfies a corresponding threshold, the wireless device 102 i) wakes the main radio 120 of the wireless device 102 from the sleep state, ii) indicates the change of the state of the main radio 120 from the sleep state to the awake state to a cellular wireless network, and iii) performs RLM using additional signals received via the main radio 120.

In some embodiments, the wireless device 102 wakens the main radio 120 of the wireless device 102 to perform RLM using the main radio 120 when the LP-WUS burst 252 indicates to waken the main radio 120. In some embodiments, each repetition of the LP-WUS 108 includes an information part 404 and a synchronization part 402; the wireless device 102 determines whether to waken the main radio 120 based on the information part 404; and the wireless device 102 processes the synchronization part 402 of the LP-WUS burst 252 to produce the one or more RLM evaluation results. In some embodiments, the information part 404 includes a wake value or a sleep value indication for the main radio, and the synchronization part 402 includes a sequence used for timing and frequency tracking. In some embodiments, processing the LP-WUS burst 252 to produce the one or more RLM evaluation results includes calculating a LP-WUS block error rate (BLER) value using MSN consecutive repetitions of the LP-WUS 108 in an evaluation window 302. In some embodiments, comparing the one or more RLM evaluation results includes comparing the LP-WUS BLER value to a LP-WUS BLER threshold to determine an in-sync or an out-of-sync (OOS) condition for the wireless device 102. In some embodiments, the LP-WUS BLER value satisfies the LP-WUS BLER threshold and indicates the OOS condition when the LP-WUS BLER value exceeds a main radio BLER threshold plus a negative BLER offset value. In some embodiments, processing the LP-WUS burst 252 to produce the one or more RLM evaluation results further includes calculating N−M+1 LP-WUS BLER values using MSN consecutive repetitions of the LP-WUS 108 in a sliding evaluation window 302 that shifts by a sliding step value for each LP-WUS BLER calculation. In some embodiments, comparing the one or more RLM evaluation results further includes comparing each of the N−M+1 LP-WUS BLER values to the LP-WUS BLER threshold to determine the in-sync or the OOS condition. In some embodiments, comparing the one or more RLM evaluation results further includes comparing an average of the N−M+1 LP-WUS BLER values to the LP-WUS BLER threshold to determine the in-sync or the OOS condition. In some embodiments, processing the LP-WUS burst 252 to produce the one or more RLM evaluation results includes calculating a LP-WUS signal-to-interference-plus-noise-ratio (SINR) value using MSN consecutive repetitions of the LP-WUS 108 in an evaluation window 302. In some embodiments, comparing the one or more RLM evaluation results includes comparing the LP-WUS SINR value to a LP-WUS SINR threshold to determine an in-sync or out-of-sync (OOS) condition for the wireless device 102. In some embodiments, the LP-WUS SINR value satisfies the LP-WUS threshold and indicates the in-sync condition when the LP-WUS SINR value rises above a main radio SINR threshold plus a positive SINR offset value. In some embodiments, performing RLM using additional signals received via the main radio 120 includes determining, using the main radio 120, whether the wireless device 102 satisfies an in-sync or an OOS condition based on measurement and processing of a set of received legacy reference signals 110. In some embodiments, the legacy reference signals 110 includes one or more of: a synchronization symbol block (SSB) signal or a channel state information reference signal (CSI-RS). In some embodiments, the main radio 120 performs RLM using the additional signals received via the main radio 120 based on a relaxed schedule having an evaluation time periodicity scaled by a positive factor K>1 over a normal RLM schedule for the main radio 120. In some embodiments, when results of performing the RLM using the additional signals received via the main radio 120 include a BLER exceeding a main radio BLER threshold plus a positive BLER offset value, the wireless device 102 switches RLM using the main radio 120 from the relaxed schedule to the normal RLM schedule.

### Representative Exemplary Apparatus

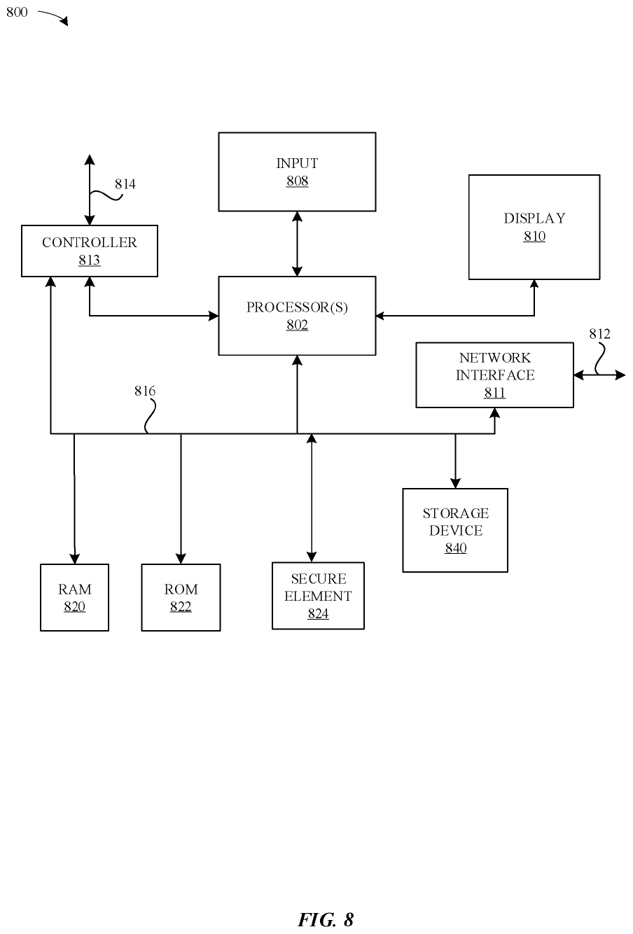

FIG. 8 illustrates in block diagram format an exemplary computing device 800 that can be used to implement the various components and techniques described herein, according to some embodiments. In particular, the detailed view of the exemplary computing device 800 illustrates various components that can be included in a wireless device 102. As shown in FIG. 8, the computing device 800 can include one or more processors 802 that represent microprocessors or controllers for controlling the overall operation of computing device 800. In some embodiments, the computing device 800 can also include a user input device 808 that allows a user of the computing device 800 to interact with the computing device 800. For example, in some embodiments, the user input device 808 can take a variety of forms, such as a button, keypad, dial, touch screen, audio input interface, visual/image capture input interface, input in the form of sensor data, etc. In some embodiments, the computing device 800 can include a display 810 (screen display) that can be controlled by the processor(s) 802 to display information to the user (for example, information relating to incoming, outgoing, or active communication sessions). A data bus 816 can facilitate data transfer between at least a storage device 840, the processor(s) 802, and a controller 813. The controller 813 can be used to interface with and control different equipment through an equipment control bus 814. The computing device 800 can also include a network/bus interface 811 that couples to a data link 812. In the case of a wireless connection, the network/bus interface 811 can include wireless circuitry, such as a wireless transceiver and/or baseband processor. The computing device 800 can also include a secure element 824. The secure element 824 can include an eUICC.

The computing device 800 also includes a storage device 840, which can include a single storage or a plurality of storages (e.g., hard drives), and includes a storage management module that manages one or more partitions within the storage device 840. In some embodiments, storage device 840 can include flash memory, semiconductor (solid state) memory or the like. The computing device 800 can also include a Random-Access Memory (RAM) 820 and a Read-Only Memory (ROM) 822. The ROM 822 can store programs, utilities or processes to be executed in a non-volatile manner. The RAM 820 can provide volatile data storage, and stores instructions related to the operation of the computing device 800.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), 5G, and/or 5G-Advanced or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when 5G, LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for radio link monitoring (RLM) of a cellular wireless network, the method comprising:
by a wireless device:
transitioning a low-power wake-up radio (LP-WUR) from a sleep state to an awake state;
receiving, via the LP-WUR, a low-power wake-up signal (LP-WUS) burst comprising N repetitions of a LP-WUS;
determining that the LP-WUS burst indicates to keep a main radio of the wireless device asleep;
processing the LP-WUS burst to produce one or more RLM evaluation results;
comparing the one or more RLM evaluation results to corresponding thresholds; and
when at least one of the one or more RLM evaluation results satisfies a corresponding threshold:
waking the main radio of the wireless device;
indicating the awake state of the main radio to the cellular wireless network;
receiving additional signals via the main radio; and
performing RLM using the additional signals received via the main radio.

2. The method of claim 1, wherein:
each repetition of the N repetitions of the LP-WUS burst comprises an information part and a synchronization part;
the determination to keep the main radio asleep is based on the information part; and
the synchronization part of the LP-WUS burst is processed to produce the one or more RLM evaluation results.

3. The method of claim 2, wherein:
the information part comprises a wake value or a sleep value indication for the main radio; and
the synchronization part comprises a sequence used for timing and frequency tracking.

4. The method of claim 1, wherein:
processing the LP-WUS burst to produce the one or more RLM evaluation results comprises calculating a LP-WUS block error rate (BLER) value using MSN consecutive repetitions of the LP-WUS in an evaluation window; and
comparing the one or more RLM evaluation results comprises comparing the LP-WUS BLER value to a LP-WUS BLER threshold to determine an in-sync condition or an out-of-sync (OOS) condition for the wireless device,
wherein the LP-WUS BLER value satisfies the LP-WUS BLER threshold and indicates the OOS condition when the LP-WUS BLER value exceeds a main radio BLER threshold plus a negative BLER offset value.

5. The method of claim 4, wherein processing the LP-WUS burst to produce the one or more RLM evaluation results further comprises calculating N−M+1 LP-WUS BLER values using MSN consecutive repetitions of the LP-WUS in a sliding evaluation window that shifts by a sliding step value for each LP-WUS BLER calculation.

6. The method of claim 5, wherein comparing the one or more RLM evaluation results further comprises comparing each of the N−M+1 LP-WUS BLER values to the LP-WUS BLER threshold to determine the in-sync condition or the OOS condition.

7. The method of claim 5, wherein comparing the one or more RLM evaluation results further comprises comparing an average of the N−M+1 LP-WUS BLER values to the LP-WUS BLER threshold to determine the in-sync condition or the OOS condition.

8. The method of claim 1, wherein
processing the LP-WUS burst to produce the one or more RLM evaluation results comprises calculating a LP-WUS signal-to-interference-plus-noise-ratio (SINR) value using MSN consecutive repetitions of the LP-WUS in an evaluation window; and
comparing the one or more RLM evaluation results comprises comparing the LP-WUS SINR value to a LP-WUS SINR threshold to determine an in-sync condition or an out-of-sync (OOS) condition for the wireless device,
wherein the LP-WUS SINR value satisfies the LP-WUS SINR threshold and indicates the in-sync condition when the LP-WUS SINR value rises above a main radio SINR threshold plus a positive SINR offset value.

9. The method of claim 1, wherein the performing RLM using the additional signals received via the main radio comprises determining, using the main radio, whether the wireless device satisfies an in-sync condition or an out-of-sync (OOS) condition based on measurement and processing of a set of received legacy reference signals.

10. The method of claim 9, wherein the set of received legacy reference signals comprise one or more of: a synchronization symbol block (SSB) signal or a channel state information reference signal (CSI-RS).

11. The method of claim 9, wherein the main radio performs RLM using the additional signals received via the main radio based on a relaxed schedule having an evaluation time periodicity scaled by a positive factor K>1 over a normal RLM schedule for the main radio.

12. The method of claim 11, further comprising:
by the wireless device:
when results of performing the RLM using the additional signals received via the main radio include a BLER exceeding a main radio BLER threshold plus a positive BLER offset value, switching RLM using the main radio from the relaxed schedule to the normal RLM schedule.

13. An apparatus configurable for operation in a wireless device, the apparatus comprising one or more processors coupled to a memory storing instructions that, when executed by the one or more processors, configure the wireless device to:
transition a low-power wake-up radio (LP-WUR) from a sleep state to an awake state;
receive, via the LP-WUR, a low-power wake-up signal (LP-WUS) burst comprising N repetitions of a LP-WUS;
determine that the LP-WUS burst indicates to keep a main radio of the wireless device asleep;
process the LP-WUS burst to produce one or more radio link monitoring (RLM) evaluation results;
compare the one or more RLM evaluation results to corresponding thresholds; and
when at least one of the one or more RLM evaluation results satisfies a corresponding threshold:
wake the main radio of the wireless device;
indicate the awake state of the main radio to a cellular wireless network;
receive additional signals via the main radio; and
perform RLM using the additional signals received via the main radio.

14. The apparatus of claim 13, wherein:
each repetition of the N repetitions of the LP-WUS comprises an information part and a synchronization part;
the determination to keep the main radio asleep is based on the information part; and
the synchronization part of the LP-WUS burst is processed to produce the one or more RLM evaluation results.

15. The apparatus of claim 14, wherein:
the information part comprises a wake value or a sleep value indication for the main radio; and
the synchronization part comprises a sequence used for timing and frequency tracking.

16. The apparatus of claim 13, wherein:
the wireless device processes the LP-WUS burst to produce the one or more RLM evaluation results by at least calculating a LP-WUS block error rate (BLER) value using MEN consecutive repetitions of the LP-WUS in the LP-WUS burst in an evaluation window; and
the wireless device compares the one or more RLM evaluation results by at least comparing the LP-WUS BLER value to a LP-WUS BLER threshold to determine an in-sync condition or an out-of-sync (OOS) condition for the wireless device,
wherein the LP-WUS BLER value satisfies the LP-WUS BLER threshold and indicates the OOS condition when the LP-WUS BLER value exceeds a main radio BLER threshold plus a negative BLER offset value.

17. The apparatus of claim 16, wherein:
the wireless device processes the LP-WUS burst to produce the one or more RLM evaluation results further comprises calculating N−M+1 LP-WUS BLER values using MSN consecutive repetitions of the LP-WUS signal in a sliding evaluation window that shifts by a sliding step value for each LP-WUS BLER calculation.

18. The apparatus of claim 17, wherein:
the wireless device compares the one or more RLM evaluation results by at least comparing each of the N−M+1 LP-WUS BLER values to the LP-WUS BLER threshold to determine the in-sync condition or the OOS condition.

19. The apparatus of claim 17, wherein:
the wireless device compares the one or more RLM evaluation results by at least comparing an average of the N−M+1 LP-WUS BLER values to the LP-WUS BLER threshold to determine the in-sync condition or the OOS condition.

20. A wireless device comprising:
wireless circuitry comprising a plurality of antennas; and
at least one processor communicatively coupled to the wireless circuitry and to a memory storing instructions that, when executed by the at least one processor, cause the wireless device to:
transition a low-power wake-up radio (LP-WUR) from a sleep state to an awake state;
receive, via the LP-WUR, a low-power wake-up signal (LP-WUS) burst comprising N repetitions of a LP-WUS;
determine that the LP-WUS burst indicates to keep a main radio of the wireless device asleep;
process the LP-WUS burst to produce one or more radio link monitoring (RLM) evaluation results;
compare the one or more RLM evaluation results to corresponding thresholds; and
when at least one of the one or more RLM evaluation results satisfies a corresponding threshold:
wake the main radio of the wireless device;
indicate the awake state of the main radio to a cellular wireless network;
receive additional signals via the main radio; and
perform RLM using the additional signals received via the main radio.

21-26. (canceled)
